(19) United States
(12) Patent Application Publication
(10) Pub. No.: US 2007/0136773 A1
(43) Pub. Date: Jun. 14, 2007

(54) Systems and methods for providing television services using implicit content to indicate the availability of additional content

(76) Inventors: Douglas O'Neil, Marietta, GA (US); Robert Koch, Norcross, GA (US)

Correspondence Address: JOHN S. PRATT;KILPATRICK STOCKTON LLP 36968, 1100 PEACHTREE STREET, SUITE 2800, ATLANTA, GA, 30309, US

(21) Appl. No.: 11/302,832

(22) Filed: Dec. 14, 2005

(51) Int. Cl. H04N 7/173

(52) U.S. Cl. 725/100; 725/110; 725/112; 725/113

(57) ABSTRACT

A system for providing content includes a first receiver for receiving television content, the television content having associated therewith an implicit indicator that additional content is available, at least one processor for presenting for display the television content, and a second receiver for receiving a response to the implicit indicator, the response indicating a desire to obtain the additional content.

### BACKGROUND

The technology for providing interactive content, generally referred to herein as additional content, in conjunction with television content is known. In one example of an application for providing interactive content, a viewer is presented with the opportunity to request additional, and in some cases, interactive content, through the use of an indicator, or other mechanism that is presented to the viewer along with, or triggered by, the non-interactive or conventional content. In this example, when presented with the indicator, the viewer may accept, reject or ignore the indicator to communicate to the system their willingness to view, or their indifference to, the availability of the additional content. In current systems, the availability of the additional content is communicated to the viewer through the presentation of an on-screen visual indicator, sometimes referred to as a “prompt.”

Unfortunately, the requirement of the presentation of a dedicated prompt to initiate the delivery of additional content limits the flexibility of such systems by requiring that a specific indicator inform the viewer of the availability of additional content. For example, an explicit visual prompt interrupts the presentation of the content and may distract the viewer. This may be particularly problematic if the viewer is disinterested in the additional content being explicitly offered.

### SUMMARY

Embodiments of the invention include a system for providing content. The system includes a first receiver for receiving television content, the television content having associated therewith an implicit indicator that additional content is available, at least one processor for presenting for display the television content, and a second receiver for receiving a response to the implicit indicator, the response indicating a desire to obtain the additional content.

Other embodiments are also provided. Other systems, methods, features, and advantages of the invention will be or become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE FIGURES

The invention can be better understood with reference to the following figures. The components within the figures are not necessarily to scale, emphasis instead being placed upon clearly illustrating the principles of the invention. Moreover, in the figures, like reference numerals designate corresponding parts throughout the different views.

FIG. 1 is a block diagram illustrating a system in which an embodiment of the system and method for using implicit content to indicate the availability of additional content can be implemented.

FIG. 2 is a block diagram illustrating the interactive server of FIG. 1.

FIG. 3 is a block diagram illustrating the network service provider of FIG. 1.

FIG. 4 is a block diagram illustrating the media device of FIG. 1.

FIG. 5 is a schematic diagram illustrating implicit content presented to a subscriber.

FIG. 6 is a schematic diagram illustrating implicit content presented to a subscriber, where the implicit content is used to identify an item available for purchase.

FIG. 7 is a flow chart illustrating the operation of an embodiment of the system and method for using implicit content to indicate the availability of additional content.

### DETAILED DESCRIPTION

Although described with particular reference to providing to a viewer content in addition to television content, the systems and methods for providing television services using implicit content to indicate the availability of additional content, referred to below as the systems and methods for using implicit content to indicate the availability of additional content, can be used to provide a wide variety of content to a subscriber.

The systems and methods for using implicit content to indicate the availability of additional content can be implemented in hardware, software, or a combination of hardware and software. When implemented in hardware, the systems and methods for using implicit content to indicate the availability of additional content can be implemented using specialized hardware elements and logic. When the systems and methods for using implicit content to indicate the availability of additional content is implemented partially in software, the software portion can be used to precisely control the various components in the systems. The software can be stored in a memory and executed by a suitable instruction execution system (a microprocessor, or a network of distributed processors). The hardware implementation of the systems and methods for using implicit content to indicate the availability of additional content can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

The software for the systems and methods for using implicit content to indicate the availability of additional content comprises an ordered listing of executable instructions for implementing logical functions, and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

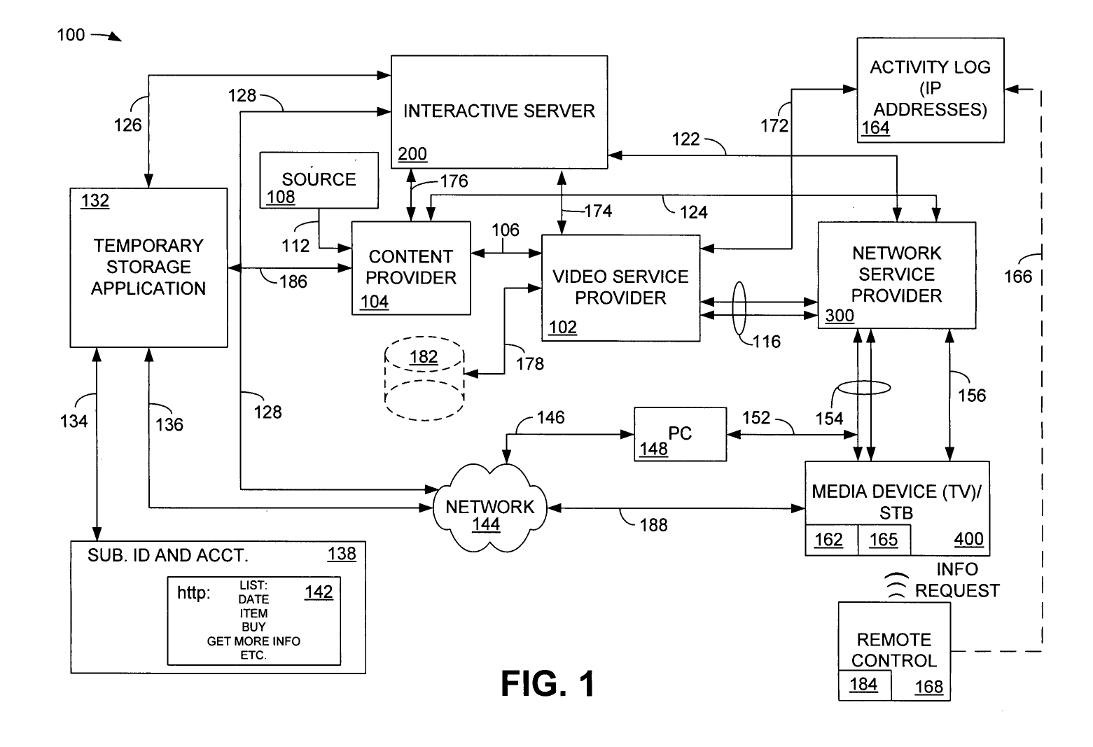

FIG. 1 is a block diagram illustrating a system 100 in which an embodiment of the systems and methods for using implicit content to indicate the availability of additional content can be implemented. The system 100 includes a video service provider 102 that provides content including television content and interactive content from one or more content providers, referred to collectively at 104, and from an interactive server 200. The content provider 104 can comprise one or more content providers that receive source material from source 108 via connection 112 and provide content to the video service provider 102 via connection 106.

The content provider 104 may be any original or secondary source of programming or information generally including, for example, interactive or non-interactive programming such as commercial television programming from television stations, cable programming, and on-line services of various types. The content provider 104 may alternatively broadcast directly to a viewer.

A content provider, such as a commercial television station, which may not provide programming via the video service provider 102 may supply to the video service provider 102 interactive applications, interactive programming, or access to other interactive services that may or may not be associated with their content. In such an application, the video service provider 102 that has received an interactive application from the content provider 104 may then provide subscriber access to the interactive application via a media device 400. The media device 400 can be, for example, a television, a receiver device typically referred to as a set top box, or any other device capable of communicating with the video service provider 102 and a network service provider 300. The network service provider 300 and the media device 400 will be described in detail below.

If the content provider 104 provides content to viewers via the network service provider 300, the content provider 104 may provide content via the video service provider 102. Such programming could be delivered to the video service provider 102 via connection 106 in the form of a radio frequency (RF) transmission in which case the signal would be received and suitably processed by the video service provider 102 and delivered to the network service provider 300 for delivery to a media device 400. Alternatively, the programming might be transmitted to the video service provider 102 via a network using cellular, packet-switching, or another suitable technology. The connection 106 between the content provider 104 and the video service provider 102 is intended to encompass many different communication methodologies and is shown as a single line for simplicity.

The video service provider 102 is coupled to the network service provider 300 via connection 116. In an embodiment, the connection 116 is a multiple channel data connection, such as an internet protocol (IP) connection that enables multiple data and control channels to be provided between the video service provider 102 and the network service provider 300. The network service provider 300 is coupled to the media device 400 via connections 154 and 156. The connection 154 is similar to the connection 116 in that it includes multiple data and control channels. The connection 156 can be, for example, the connection over which content is supplied from the network service provider 300 to the media device 400 or another bi-directional communication channel.

The media device 400 can be any device that can communicate with the network service provider 300 to receive programming, content, interactive content, and other information and provide subscriber requests to the network service provider 300. In an embodiment, the media device 400 is a set top box that is coupled to the network service provider 300 via an IP connection 154 and via a content connection 156. However, the media device 400 can be another device, processor, or transceiver capable of wired or wireless bi-directional communication with the network service provider 300 and capable of presenting for display media content including video content. In an embodiment, a personal computer (PC) 148 is coupled to the connection 154 via connection 152. The PC 148 is coupled to a network 144 via connection 146. The network 144 can be a local area network (LAN) or a wide area network (WAN), and in an embodiment, can be the world wide web (WWW).

The interactive server 200 is coupled to the video service provider 102 via connection 174 and is coupled to the content provider 104 via connection 176. The interactive server 200 is coupled to the network 144 via connection 128 and is coupled to the network service provider 300 via connection 122. The interactive server 200 can store and provide interactive content to the content provider 104, the video service provider 102 and to the network service provider 300. The functionality performed by the interactive server 200 may also be performed by one or more of the content provider 104, video service provider 102, network service provider 300 and the media device 400.

An activity log 164 is coupled to the video service provider 102 via connection 172. The activity log 164 may be an application, or a list that is maintained within the video service provider 102 or that is maintained elsewhere and made accessible to the video service provider 102. The activity log 164 records and stores subscriber activity such as a subscriber's IP address, and time and location stamps, which will be described below. A remote control 168 is used by a subscriber to communicate with the media device 400. The functionality provided by the remote control 168 may alternatively be performed by any other type of user command interface controller that permits a user to input command instructions to be interpreted and executed by the media device 400. Examples include, but are not limited to, a keyboard, mouse, touch screen, joystick, or other user interface device. In addition, an interface that allows audible control, also referred to as voice command, may allow a user to speak a command and have the spoken command interpreted and acted upon by the media device 400. For example, the verbal command “buy sweater” may be used to invoke an interactive shopping application in which the sweater that is worn by a character on a program is identified and associated with the subscriber as something that the subscriber wishes to purchase. The location at which a link to the sweater is located is associated with the subscriber and placed at a location at which the subscriber can access and, if desired, purchase the item. This will be described in greater detail below.

The remote control 168 may also include a pointing device 184 that enables the subscriber to navigate over the screen on which the content is being presented. For example, in conjunction with the media device 400, one or more portions of a display can be isolated, or otherwise identified, to form one or more clickable regions that a subscriber can navigate using the pointing device 184. When the subscriber uses the remote control 168 to communicate with the media device 400, the subscriber identification (ID) is sent from the media device 400 to the network service provider 300 and then to the video service provider 102. The video service provider 102 places the subscriber ID in the activity log 164 so that subscriber requests can be associated with the additional content desired by the subscriber. The connection 166 between the remote control 168 and the activity log 164 is shown as a dotted line to indicate that it is a logical connection and not a direct physical connection. The media device 400 may also include a logon/registration application 165 so that different users can use the media device 400. In such an implementation, each subscriber has a unique ID and would individually log on to the media device 400. In another embodiment, the media device 400 may be dedicated to a single subscriber and subscriber log on may be automatic.

A temporary storage application 132 is coupled to the interactive server 200 via connection 126, to the content provider 104 via connection 186 and to the network 144 via connection 136. The temporary storage application 132 is a location at which content requested by a subscriber for later delivery or viewing is placed. For example, if a subscriber is viewing content and, in response to an implicit prompt, wishes to access interactive content, or access a location on the WWW at a later time so that the current content is not interrupted, the subscriber can indicate to the network service provider 300 that the interactive content, or the WWW location at which the additional content is located, be stored in the temporary storage application 132. In one implementation, the temporary storage application 132 can be thought of as an account established for the subscriber into which the additional content, or an identifier to the location of the additional content, is placed for subsequent action. For example, a subscriber might click on an image, or a specific portion of an image, on the screen where the image, or portion thereof, includes an identifier, such as a link to a uniform resource locator (URL) that identifies additional content associated with that image or image portion. The URL could be placed in the temporary storage application 132 without interrupting the subscriber's viewing experience. Such applications are typically referred to as a “parking lot,” or a “shopping cart.” The temporary storage application 132 can be located within the interactive server 200, or can be located remote from the interactive server 200 and accessible via the network 144. If the additional content is desired in real-time, or near real-time, the additional content is not directed to the temporary storage application 132 and is instead delivered to the subscriber via the media device 400.

A subscriber ID list 138 is coupled to the temporary storage application via connection 134. The subscriber ID list 138 may further include one or more accounts 142. In the example shown, the account 142 comprises information relating to a WWW URL that includes information relating to interactive content requested by the subscriber and stored in the temporary storage application 132.

Optionally, a user preference profile storage element 182 can be coupled to the video service provider 102 via connection 178. The user preference profile storage element 182 makes available a database of user preferences that can be used in determining the nature of the additional content to make available to the subscriber.

The content provider 104, the interactive server 200, or another entity may supply to the video service provider 102, or alternatively to the network service provider 300, one or more interactive applications, programs, product or service descriptions, or indeed any additional content, which the video service provider 102 or the network service provider 300 may furnish to a subscriber in response to a subscriber request. The additional content may be identified by a unique address, or an identifier, that is associated with the additional content. The unique address identifies the location of the additional content. For example, the additional content may have associated with it a specific address that associates the additional content with a particular location at which the additional content is stored. The additional content may be stored in the interactive server 200, or elsewhere. One manner of associating a unique address with the additional content and the providing of content, additional content and interactive content to a subscriber is described in commonly-assigned U.S. Pat. No. 5,818,438, entitled “System And Method For Providing Television Services,” the entire disclosure of which is incorporated herein by reference. However, other methodologies of associating a unique identifier with content, interactive content, programming, a location on the WWW, etc., may also be implemented.

In accordance with an embodiment of the invention, programming received by a subscriber includes at least one instance of implicit content, or an implicit indication that additional content is available. The original content can be any programming content, such as commercial television programming, cable television programming, video-on-demand programming, pay-per-view programming, etc. The additional content may include, for example, interactive content, additional television programming content, information relating to products and/or services that might be of interest to the subscriber, or any content or application in addition to the original content delivered to the subscriber.

The implicit content, or implicit indicator, may include, for example, some or all of a video image that is transmitted to the subscriber as part of the programming, an image of a product or service that appears on all or part of the screen as part of the programming delivered to a subscriber, a specially created or modified image that is displayed on the screen, a portion of the screen isolated and that functions as a clickable, or otherwise selectable, icon, a time period during which a subscriber can indicate interest in the additional content, information, including visible and audible information that is transmitted to the subscriber as part of the programming, or another event that triggers subscriber interaction. The implicit content, or indicator, may appear at a specific time and for a specific duration in the programming. Advantageously, in an embodiment, the implicit content, or indicator, does not interrupt the normal visual appearance of the video content and would be otherwise undetectable to the viewer unless the viewer knew by some other mechanism that it was present. In an embodiment, the subscriber has advance knowledge that the implicit content, or indicator, will be included in the programming content.

In response to the implicit content, the subscriber may indicate interest in the additional content by, for example, using the remote control 168 to communicate a request for the additional content to the media device 400. When the subscriber indicates interest in the additional content, a subscriber ID, a time stamp and a location stamp are associated with the subscriber's request. For example, when the subscriber uses the remote control 168 to request the additional content, the media device 400, or, in some applications, the network service provider 300 or the video service provider 102, identifies the subscriber request with a subscriber ID, and also associates with the subscriber request the point in time in the programming content at which the subscriber request occurs and the location on the screen that the subscriber has indicated. The time stamp indicates the point in time in the programming at which the subscriber has indicated interest. The location refers to screen coordinates that indicate the screen location corresponding to the subscriber's request. The time stamp and location stamp will be described in detail below. This is generally referred to as a time/location stamp or a frame tag.

The subscriber ID, the point in time and the location information are forwarded to the activity log 164 for storage and later retrieval. The subscriber ID and the time/location stamp information allow the video service provider 102, the interactive server 200, or any provider of additional content to accurately determine the identity of the additional information requested by the subscriber by associating the implicit content (for example, the frame viewed by the subscriber) that was identified by the subscriber with the additional content associated with the implicit content. The subscriber ID and the time/location stamp information will be described in detail below.

The request for additional content is relayed by the media device 400 to the network service provider 300 via connection 154. Depending on the nature of the additional content, the network service provider 300 relays the subscriber request to the video service provider 102, to the interactive server 200 or to any other provider of additional content that corresponds to the subscriber request. If, for example, the subscriber request for additional content relates to additional television content, or interactive content, then the additional content is identified using, for example, an additional content identifier and the time/location stamp information, and delivered to the subscriber via the network service provider 300 and the media device 400. If, for example, the subscriber request for additional content relates to a product or service that is located on the WWW, then the additional content is identified using, for example, the URL of the website and the time/location stamp information, and either immediately delivered to the subscriber via the network service provider 300 and the media device 400, or placed in the temporary storage application 132 for later retrieval by the subscriber. In one example, the subscriber may use client software 162 located in the media device 400 to access the temporary storage application 132 over the network 144 via connections 188 and 136. Alternatively, the subscriber may use the PC 148 to access the temporary storage application 132 over the network 144.

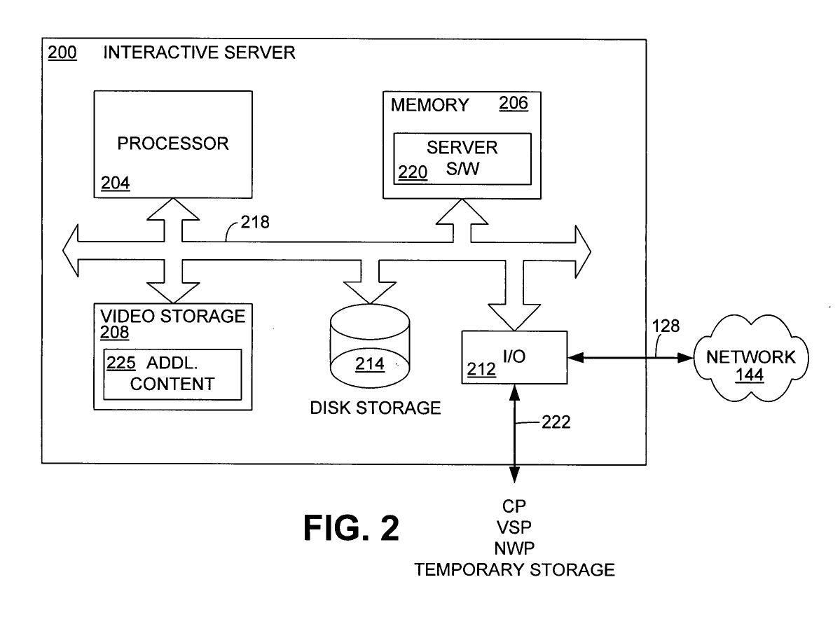

FIG. 2 is a block diagram illustrating the interactive server 200 of FIG. 1. The interactive server 200 includes a processor 204, a memory 206, a video storage element 208, an input/output element 212 and a disk storage element 214 in communication via bus 218. The bus 218, though shown as a single bus, may be implemented using a number of busses connected as appropriate among the subsystems within the interactive server 200. The processor 204 and the memory 206 provide the signal timing, processing and storage functions for the interactive server 200. The video storage element 208 also includes additional content 225 that can be provided to the subscriber by the interactive server 200. In this example, the additional content 225 comprises video content. However, the additional content 225 may comprise any additional content as described herein. The additional content 225 may also be stored in the disk storage element 214. The additional content need not be video content but may be any addressable content that may be provided to and displayed by the media device 400 or the associated PC 148.

The memory 206 includes server software 220. The server software 220 can be executed by the processor 204 to associate the additional content with the subscriber request and deliver the additional content 225 to the subscriber as mentioned above. The input/output element 212 controls the input and output functionality of the interactive server 200 and is coupled to the network 144 via connection 128. The input/output element 212 also couples to the temporary storage application 132 via connection 126, the content provider 104 via connection 176, the video service provider 102 via connection 174 and to the network service provider 300 via connection 122, although these connections are collectively illustrated in FIG. 2 as connection 222.

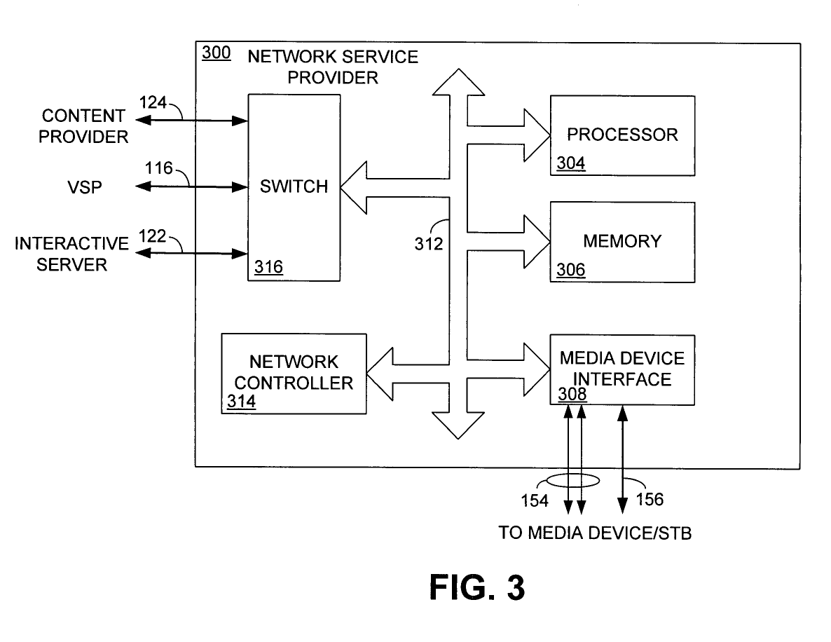

FIG. 3 is a block diagram illustrating the network service provider 300 of FIG. 1. The network service provider 300 includes a processor 304, a memory 306, a media device interface 308, a network controller 314 and a switch 316 in communication via bus 312. The bus 312, though shown as a single bus, may be implemented using a number of busses connected as appropriate among the subsystems within the network service provider 300. The processor 304 and the memory 306 provide the signal timing, processing and storage functions for the network service provider 300. The network controller 314 controls the operating functions of the network service provider 300 and controls the operation of the switch 316. The switch 316 determines the source of the content that is provided to a subscriber. In this example, the network service provider may receive content from the content provider 104 (FIG. 1) via connection 124, from the video service provider 102 (FIG. 1) via connection 116 and from the interactive server 200 (FIG. 1) via connection 122. The media device interface 308 provides the logical and physical interface to the media device 400 (FIG. 1).

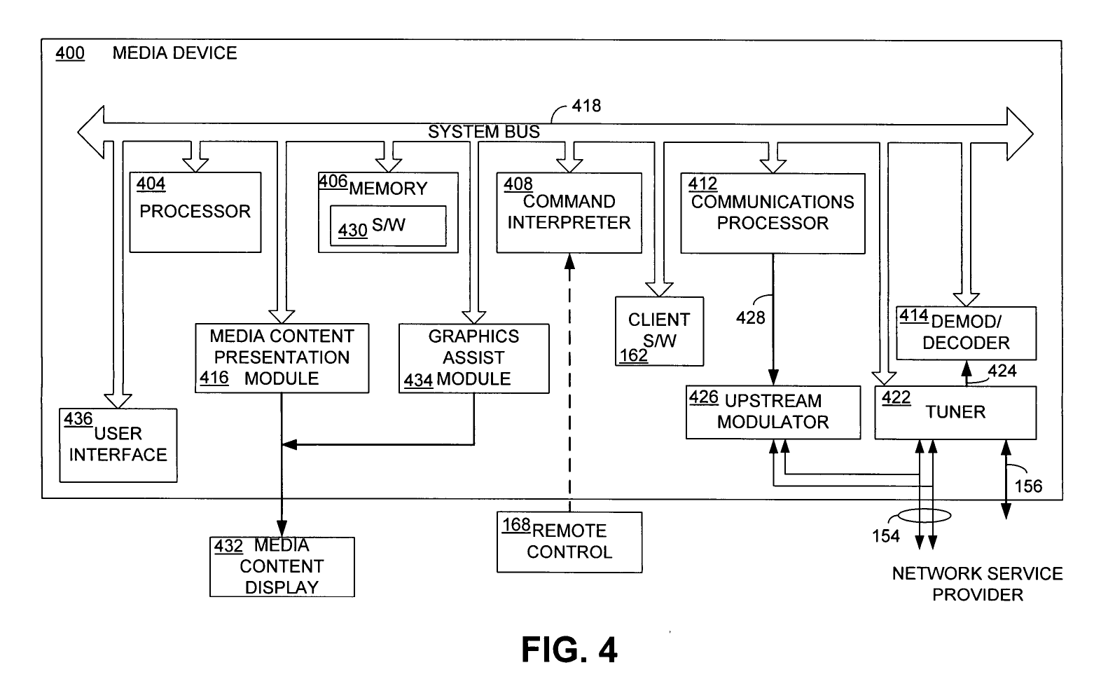

FIG. 4 is a block diagram illustrating the media device 400 of FIG. 1. The media device 400 includes a processor 404, a memory 406, a command interpreter 408, a communications processor 412, a demodulator and decoder (demod/decoder) 414, a graphics assist module 434, a user interface 436, client software 162 and a media content presentation module 416 in communication via bus 418. The bus 418, though shown as a single bus, may be implemented using a number of busses connected as appropriate among the subsystems within the media device 400. The media device 400 also includes a tuner 422 that is coupled to the demod/decoder 414 via connection 424. An upstream modulator 426 is coupled to the communications processor 412 via connection 428 and to the network service provider via connection 154.

The tuner 422 receives the programming content from the network service provider 300. The tuner 422 may be any analog or digital receiving device adapted to receive, descramble and process video programming from the network service provider 300. The output of the tuner 422 is provided via connection 424 to the demod/decoder 414. The demod/decoder 414 demodulates and decodes the video signal and provides the video signal on the bus 418. The media content presentation module 416 converts the video information provided by the demod/decoder 414 into a signal that can be presented to a subscriber on a media content display 432. The media content display 432 may be external to the media device 400, or may be incorporated into the media device 400, for example when the media device is a television.

The graphics assist module 434 can be any graphics processor that can add graphics, a graphics overlay, or otherwise modify the video signal provided by the demod/decoder 414 in response to instructions from the processor 404 executing the software 430. In one example, the implicit content, or an implicit indicator, that is presented to a subscriber can be a highlighted portion of the screen of the media content display 432. In such an implementation, the graphics assist module 434 is used to alter, or otherwise highlight the portion of the screen containing the implicit content.

The user interface 436 processes subscriber requests and interacts with the client software 162 to allow a subscriber to access the temporary storage application 132 (FIG. 1) to access content that is located there.

The processor 404 and the memory 406 provide the signal timing, processing and storage functions for the media device 400. The processor 404 may be any suitable processor for implementing the functions of the media device 400. Interaction by the subscriber with the media device 400 is typically via the remote control 168. The command interpreter 408 receives the signals from the remote control 168 and places the signals on the bus 418 for execution by the processor 404, communications processor 412, the demod/decoder 414, the user interface 436 and the tuner 422. Alternatively, the command interpreter 408 receives, interprets and places on the bus 418 any input received from a subscriber. For example, in an embodiment, the command interpreter 408 is configured to receive audible input from a subscriber. In other embodiments, the command interpreter 408 can receive inputs from a subscriber using a variety of technologies. The command interpreter 408 can also send messages to the CPU 404 via the bus 418 when a subscriber responds to implicit content contained in the programming content.

Interaction upstream by the media device 400 is accomplished by the communications processor 412 and the upstream modulator 426. The communications processor 412 can be any processor suitable for converting information on the bus 418 into a protocol that can be transmitted to the network service provider 300 via connections 154 and/or 156. In one example, the communications processor converts information on the bus 418 into IP format and the upstream modulator 426 modulates and transmits the signals via connection 154.

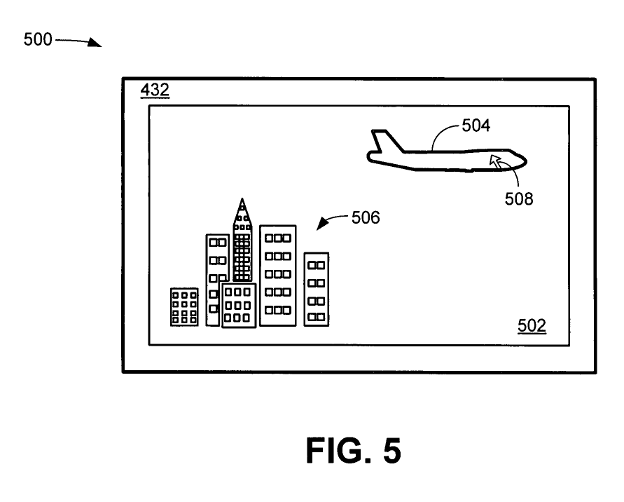

FIG. 5 is a schematic diagram illustrating implicit content presented to a subscriber. FIG. 5 includes the media content display 432 of FIG. 4 including a screen 502 on which content is presented to the subscriber. In the example shown in FIG. 5, the content comprises video images 504 and 506. The image 504 represents the implicit content. For example, in an embodiment, the subscriber can navigate using the remote control 168 and the pointing device 184 (FIG. 1) to place a cursor 508 on the image 504 and click on the image 504. As an example, the image 504 represents implicit content that corresponds to additional content. The additional content may be travel related services, a commercial for a particular airline, or any other additional content that is associated with the implicit content represented by image 504. In another embodiments, clicking anywhere on the screen 502 can invoke the additional content.

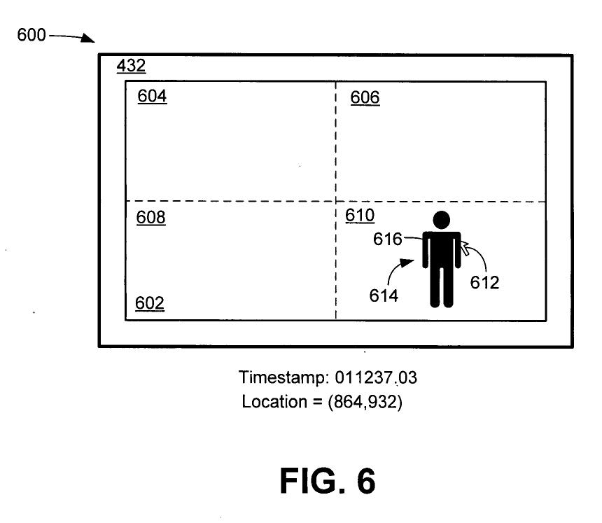

FIG. 6 is a schematic diagram illustrating implicit content presented to a subscriber, where the implicit content is used to identify an item available for purchase. FIG. 6 includes the media content display 432 of FIG. 4 including a screen 602 on which content is presented to the subscriber. The screen 602 is divided into quadrants 604, 606, 608 and 610. However, the screen 602 can be divided into regions other than quadrants. The screen 602 typically comprises picture elements, also referred to as pixels that are arranged in horizontal rows and vertical columns. A greater number of pixels equates to higher screen display resolution. Because the screen is defined by a matrix of pixels, particular locations on the screen are individually addressable per pixel and therefore, identifiable. For example, a particular location on the screen 602, for example, the image 614 in quadrant 610, can be identified by the location of at least one of the pixels that comprise the image 614. The resolution of a screen is determined by the number of pixels. A resolution of, for example, 1024×768 means that there are 1024 pixels in each row and that there are 768 rows. In an example, a pixel located at position 864, 932 (where the first number represents horizontal location and the second number represents vertical location) is part of the image 614. In this manner, a particular location on the screen 602 can be identified and by clicking on a pixel located within the image 614, subscriber interest is indicated.

In the example shown in FIG. 6, the content comprises a video presentation including the video image 614, which, in this example, represent a person wearing a sweater 616. The image 614, and specifically, the sweater 616, represents the implicit content. For example, in an embodiment, the subscriber can navigate using the remote control 168 and the pointing device 184 (FIG. 1) to place a cursor 612 on the screen 602, in the quadrant 610, or on the image 614. By clicking, the subscriber indicates interest in the sweater 616. Alternatively, the subscriber may indicate interest in the sweater 616 in another manner, such as pressing a button on the remote control 168, by uttering an audible command, or by another manner of communicating subscriber interest to the media device 400.

In an example, the programming content that includes the image 614 is digitized and includes a video program identifier and an identifier for each frame, which is referred to as a video frame identifier. The combination of the video program identifier and the video frame identifier comprise sufficient information to generate a time stamp when the subscriber responds to the implicit content. When the subscriber clicks on the image 614, the video program identifier and video frame identifier are read by the client software 162 in media device 400 and maintained in memory 406 during the entire viewing session. When the viewer clicks on the implicit content within the video program, the media device 400 records the screen coordinates of the curser location (e.g., location (864, 932)) on the screen and sends to the activity log 164 the following: the subscriber ID, video program identifier, video frame identifier, and screen coordinates of the curser. In other words, a timestamp associated with the specific time in the programming at which the subscriber indicated their interest is assigned to the subscriber and a location stamp corresponding to the location on the screen 602 at which the subscriber indicated interest is also determined and associated with the subscriber request. In an example, a timestamp of 011237.03, corresponding to a video program and a frame in the video program, and a location stamp of (864, 932), corresponding to a location on the screen 602, is, in this example, associated with the subscriber ID for this request. In addition, a keyword, such as “sweater” may be associated with this request. The time, location and keyword information is mapped by the interactive server 200 to an interactive content address such as a URL, or other type of address. In this example, the subscriber request can be mapped to a WWW location that sells the sweater 616.

The assigning of a timestamp to the subscriber request should also take into account that the programming might be time shifted. For example, in some instances, programming is recorded on a personal video recorder (PVR) or other such recording device, and viewed at a later time. This type of viewing is typically referred to as “time-shifted” viewing.

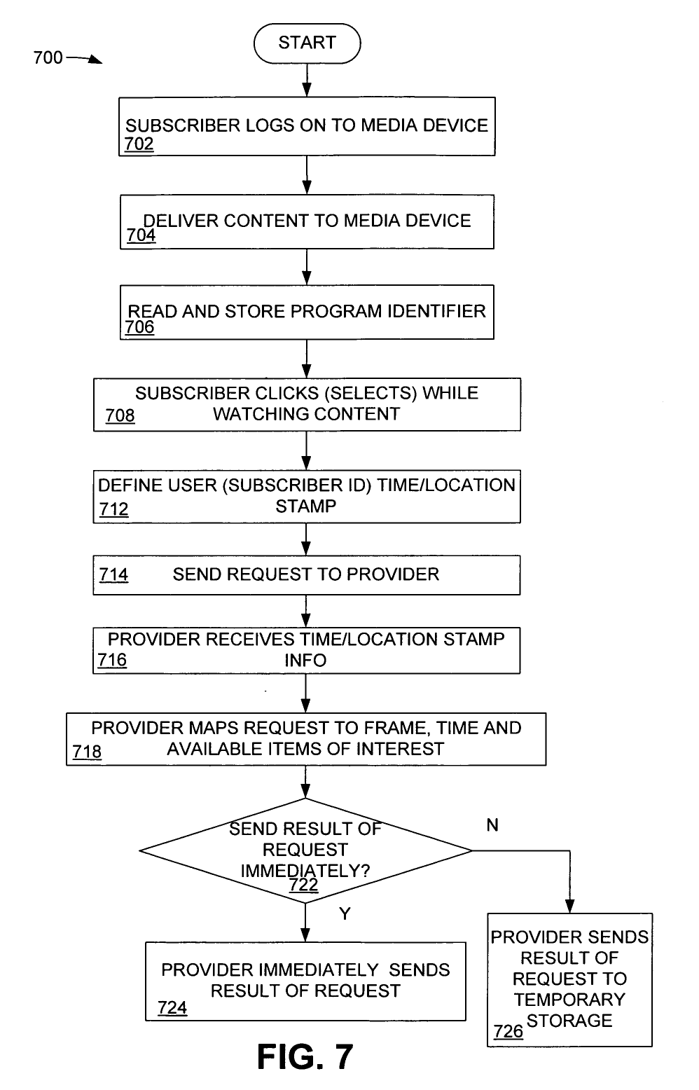

FIG. 7 is a flow chart 700 illustrating the operation of an embodiment of the system and method for using implicit content to indicate the availability of additional content. The blocks in the flow chart 700 may be performed out of the order shown. In block 702, a subscriber logs on to the media device 400 and thereby indicates interest in receiving implicit content. The subscriber may log on manually or automatically. In block 704, content, which is also referred to as original content to distinguish it from additional content, is delivered to the subscriber via the media device 400. The content can be any programming content, such as commercial television programming, cable television programming, video-on-demand programming, pay-per-view programming, etc. The content delivered in block 704 includes implicit content, or an implicit indicator, that additional content is available. The implicit content may include, for example, some or all of a video image that is transmitted to the subscriber as part of the programming, an image of a product or service that appears on all or part of the screen as part of the programming delivered to a subscriber, a specially created or modified image that is displayed on the screen, a portion of the screen isolated and that functions as a clickable or otherwise selectable icon, a time period during which a subscriber can indicate interest in the additional content, information, including visible and audible information that is transmitted to the subscriber as part of the programming, or another event that triggers subscriber interaction. The implicit content, or indicator, may appear at a specific time and for a specific duration in the programming. Advantageously, in an embodiment, the implicit content, or indicator, does not interrupt the normal visual appearance of the video content and would be otherwise undetectable to the viewer unless the viewer knew by some other mechanism that it was present. In an embodiment, the subscriber has advance knowledge that the implicit content, or indicator, will be included in the programming content.

In block 706, the media device 400 reads and stores the video program identifier.

In block 708 the subscriber responds to the implicit content by, for example, using the remote control 168 (FIG. 1) to click on, or otherwise indicate a response to the implicit content. In one example, the subscriber may indicate interest in the additional content by, for example, using the remote control 168 to communicate a request for the additional content to the media device 400. There may be a dedicated button on the remote control 168 or there may be a dedicated portion on the screen that the subscriber may indicate using a pointing device 184 that is associated with the remote control 168.

In block 712, when the subscriber indicates interest in the additional content, a subscriber ID, a time stamp and a location stamp, as described above, are associated with the subscriber's request. For example, when the subscriber uses the remote control 168 to request the additional content, the media device 400, or, in some applications, the network service provider 300 or the video service provider 102, identifies the subscriber request with a subscriber ID, and also associates with the subscriber request the time (e.g., the video program identifier and the video frame identifier) in the programming content at which the subscriber request occurs. The location on the screen at which the subscriber has indicated interest is also associated with the request. This is referred to as a time/location stamp or a frame tag. The subscriber ID, the video program identifier, video frame identifier and the location information are forwarded to the activity log 164 for storage and later retrieval. The subscriber ID and the time/location stamp information allows the video service provider 102, the interactive server 200, or any other provider of additional content to accurately determine the identity of the additional information requested by the subscriber by associating the implicit content (i.e., the frame viewed by the subscriber) that was identified by the subscriber with the additional content associated with the implicit content.

In block 714, the request for additional content is relayed by the media device 400 to the network service provider 300 via connection 154. Depending on the nature of the additional content, the network service provider 300 relays the subscriber request to the video service provider 102, to the interactive server 200, or to any other provider of additional content that corresponds to the subscriber request. In block 716, the video service provider 102, the interactive server 200, or any other provider of additional content that corresponds to the subscriber request receives the subscriber ID and the time/location stamp information. In block 718, the interactive server 200, the video service provider 102, or another provider of additional content that corresponds to the subscriber request maps the subscriber ID and the time/location stamp information to any additional content that is available to the subscriber. In block 722 it is determined whether the request for additional content is for content that is to be delivered immediately to the user, or whether the request is for additional content that is to be placed in the temporary storage application 132 (FIG. 1) for later retrieval by the subscriber.

If, for example, the subscriber request for additional content relates to additional television content, interactive content, or any other additional content that is to be immediately provided to the subscriber then, in block 724, the additional content is identified using, for example, the subscriber ID, the time/location stamp information, and is immediately delivered to the subscriber via the network service provider 300 and the media device 400. If, for example, the subscriber request for additional content relates to product or service information that is located on the WW, and the subscriber does not wish to immediately access the additional content, then, in block 726, the additional content is identified using, for example, the URL of the website, the subscriber ID, and the time/location stamp information, and placed in the temporary storage application 132 for later retrieval by the subscriber. In one example, the subscriber may use client software 162 located in the media device 400 to access the temporary storage application 132 over the network 144. Alternatively, the subscriber may use the PC 148 to access the temporary storage application 132 over the network 144.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A system for providing content, comprising:
a first receiver for receiving television content, the television content having associated therewith an implicit indicator that additional content is available;
at least one processor for presenting for display the television content; and
a second receiver for receiving a response to the implicit indicator, the response indicating a desire to obtain the additional content.

2. The system of claim 1, wherein the implicit indicator is chosen from at least one image presented to a user in the television content, an image of a product or service that appears on all or part of a screen as part of programming delivered to a subscriber, a portion of the screen that functions as a clickable icon, a time period during which a subscriber can indicate interest in the additional content, and audible information that is transmitted to the subscriber.

3. The system of claim 1, wherein the implicit indicator comprises the entire content presented in the television content

4. The system of claim 1, wherein the additional content comprises interactive television content.

5. The system of claim 1, wherein the additional content comprises a link to a uniform resource locator (URL).

6. The system of claim 1, wherein the additional content is delivered immediately to a user.

7. The system of claim 1, wherein the additional content is delivered to a user after a delay.

8. The system of claim 5, further comprising an account established for the user, the account being associated with the URL, and in which the account further comprises information relating to the additional content.

9. The system of claim 8, wherein the account further comprises a location that stores information relating to the additional content requested by the user.

10. A method for providing content, comprising:
presenting for display original content, the original content including an implicit indication that additional content is available;
receiving a response to the implicit indication, the response indicating a desire to obtain the additional content; and
presenting for display the additional content.

11. The method of claim 10, wherein the implicit indication is chosen from at least one image presented to a user in the original content and an audio message in the original content.

12. The method of claim 10, wherein the implicit indication comprises the entire original content.

13. The method of claim 10, wherein the additional content comprises interactive television content.

14. The method of claim 10, wherein the additional content comprises a link to a uniform resource locator (URL).

15. The method of claim 10, further comprising immediately delivering the additional content to a user.

16. The method of claim 10, further comprising delivering the additional content to a user after a delay.

17. The method of claim 14, further comprising establishing an account for a user, the account being associated with the URL, and in which the account further comprises information relating to the additional content.

18. The method of claim 17, wherein the account further comprises a location that stores information relating to the additional content requested by the user.

19. A computer program product for providing content, comprising computer-readable instructions for performing the steps of:
presenting for display original content, the original content including an implicit indication that additional content is available;
receiving a response to the implicit indication, the response indicating a desire to obtain the additional content; and
presenting for display the additional content.

20. The computer program product of claim 19, wherein the implicit indication is chosen from at least one image presented to a user in the original content and an audio message in the original content.

21. The computer program product of claim 19, wherein the implicit indication comprises the entire original content.

22. The computer program product of claim 19, wherein the additional content comprises interactive television content.

23. The computer program product of claim 19, wherein the additional content comprises a link to a uniform resource locator (URL).

24. The computer program product of claim 19, further comprising immediately delivering the additional content to a user.

25. The computer program product of claim 19, further comprising delivering the additional content to a user after a delay.

26. The computer program product of claim 23, further comprising establishing an account for a user, the account being associated with the URL, and in which the account further comprises information relating to the additional content.

27. The computer program product of claim 26, wherein the account further comprises a location that stores information relating to the additional content requested by the user.

28. A method for providing content, comprising:
forwarding for display television content, the television content including an implicit indication that additional content is available;
receiving in an interactive server processor a response to the implicit indication, the response indicating a desire to obtain the additional content; and
forwarding by the interactive server for display the additional content.

29. The method of claim 28, wherein the implicit indication is chosen from at least one image presented to a user in the television content and an audio message in the television content.

30. The method of claim 28, wherein the implicit indication comprises the entire content presented in the television content.

31. The method of claim 28, wherein the additional content comprises interactive television content.

32. The method of claim 28, wherein the additional content comprises a link to a uniform resource locator (URL).

33. The method of claim 28, further comprising immediately delivering the additional content to a user.

34. The method of claim 28, further comprising delivering the additional content to a user after a delay.

35. The method of claim 32, further comprising establishing an account for a user, the account being associated with the URL, and in which the account further comprises information relating to the additional content.

36. The method of claim 35, wherein the account further comprises a location that stores information relating to the additional content requested by the user.
